(19) United States
(12) Patent Application Publication
(10) Pub. No.: US 2017/0102470 A1
(43) Pub. Date: Apr. 13, 2017

(54) MULTICOMPONENT PASSIVE SEISMIC IMAGING USING GEOMETRICAL OPTICS

(71) Applicant: Microseismic, Inc., Houston, TX (US)

(72) Inventors: Aleksandar Jeremic, Houston, TX (US); Michael P. Thornton, Houston, TX (US)

(21) Appl. No.: 15/292,152

(22) Filed: Oct. 13, 2016

Related U.S. Application Data
(60) Provisional application No. 62/240,853, filed on Oct. 13, 2015.

(51) Int. Cl. G01V 1/28; G01V 1/42

(52) U.S. Cl. CPC G01V 1/288; G01V 1/42; G01V 2210/1234

(57) ABSTRACT

A method for passive seismic imaging includes entering into a programmable computer seismic signals measured at a plurality of spaced apart locations above a volume of Earth's subsurface to be evaluated. The signals are measured at each location along different directions to enable resolution of motion in three orthogonal directions. A seismic moment tensor is determined for at least one seismic event occurring in the subsurface from the measured seismic signals. Divergence-free transverse) and curl-free longitudinal components of a source term are determined from the moment tensor, seismic velocities, and the measured seismic signals. An image is generated at at least one point in the subsurface using the determined components.

### CROSS REFERENCE TO RELATED APPLICATIONS

Priority is claimed from U.S. Provisional Application No. 62/240,853 filed Oct. 13, 2015.

### STATEMENT REGARDING FEDERALLY SPONSORED RESEARCH OF DEVELOPMENT

Not Applicable.

### NAMES TO THE PARTIES TO A JOINT RESEARCH AGREEMENT

Not Applicable.

### BACKGROUND

This disclosure relates generally to the field of imaging the Earth's subsurface using seismic signals originating from events occurring in the subsurface (“passive seismic signals”). More specifically, the disclosure relates to methods for processing passive seismic signals to determine the original time and spatial position (collectively, “hypocenters”) of events in the subsurface.

Passive seismic data recorded by surface arrays, which have large apertures, wide azimuths and high fold, are routinely used for imaging of microseismicity that occurs during hydraulic fracturing (Duncan, P., and L. Eisner, 2010, Reservoir characterization using surface microseismic monitoring, Geophysics, 75(5), A139-A146). Mapping of the microseismicity created during hydraulic fracturing, when low permeability (“tight”) shale formations are stimulated in order to increase permeability, is critical to understanding the well efficiency, to optimize completion processes and to maximize production.

### BRIEF DESCRIPTION OF THE DRAWINGS

FIG. 1 shows an example of passive seismic signal acquisition that may be used in some embodiments.

FIG. 2 shows a flow chart of an example process according to the present disclosure.

FIG. 3 shows an example computer system that may be used in some embodiments.

### DETAILED DESCRIPTION

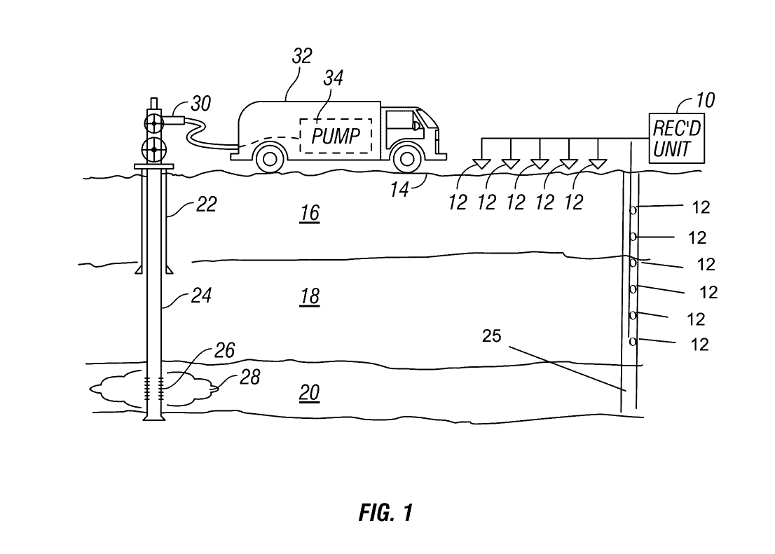

FIG. 1 shows a typical arrangement of seismic sensors as they would be used in one application of a method according to the present disclosure. The embodiment illustrated in FIG. 1 is associated with an application for passive seismic emission tomography known as “frac monitoring.”

In FIG. 1, each of a plurality of seismic sensors, shown generally at 12, is deployed at a selected position proximate the Earth's surface 14. In marine applications, the seismic sensors would typically be deployed on the water bottom in a device known as an “ocean bottom cable.” The seismic sensors 12 in the present embodiment may be geophones, but may also be accelerometers or any other sensing device known in the art that is responsive to velocity, acceleration or motion of the particles of the Earth proximate the sensor. The seismic sensors may be single component (i.e., having only one direction of sensitivity) or may be multi-component (i.e., having two or more sensitive directions). In some embodiments, the seismic sensors may measure velocity, acceleration or motion along three mutually orthogonal directions. The seismic sensors 12 may generate electrical or optical signals in response to the particle motion or acceleration, and such signals are ultimately coupled to a recording unit 10 for making a time-indexed recording of the signals from each sensor 12 for later interpretation by a method according to the present disclosure. In other implementations, the seismic sensors 12 may be disposed at various positions within a wellbore 25 drilled through the subsurface formations. A particular advantage of the method of the described herein is that it provides generally useful results when the seismic sensors are disposed at or near the Earth's surface. Surface deployment of seismic sensors is relatively cost and time effective as contrasted with subsurface sensor emplacements typically needed in methods known in the art prior to the present invention.

In some embodiments, the seismic sensors 12 may be arranged in sub-groups having spacing therebetween less than about one-half the expected wavelength of seismic energy from the Earth's subsurface that is intended to be detected. Signals from all the sensors in one or more of the sub-groups may be added or summed to reduce the effects of noise in the detected signals.

In other embodiments, the seismic sensors 12 may be placed in a monitor wellbore 25 displaced from the fracture pumping wellbore 24, either permanently for certain long-term monitoring applications, or temporarily, such as by wireline conveyance, tubing conveyance or any other sensor conveyance technique known in the art. Either surface or wellbore sensors may be used, or both, however it is not necessary to have both wellbore deployed and surface sensors.

A wellbore 22 is shown drilled through various subsurface Earth formations 16, 18, through a hydrocarbon producing formation 20. A wellbore tubing 24 having perforations 26 formed therein corresponding to the depth of the hydrocarbon producing formation 20 is connected to a valve set known as a wellhead 30 disposed at the Earth's surface. The wellhead may be hydraulically connected to a pump 34 in a frac pumping unit 32. The frac pumping unit 32 is used in the process of pumping a fluid, which in some instances includes selected size solid particles, collectively called “proppant”, are disposed. Pumping such fluid, whether propped or otherwise, is known as hydraulic fracturing. The movement of the fluid is shown schematically at the fluid front 28 in FIG. 1. In hydraulic fracturing techniques known in the art, the fluid is pumped at a pressure which exceeds the fracture pressure of the particular producing formation 20, causing it to rupture, and form fissures therein. The fracture pressure is generally related to the pressure exerted by the weight of all the formations 16, 18 disposed above the hydrocarbon producing formation 20, and such pressure is generally referred to as the “overburden pressure.” In propped fracturing operations, the particles of the proppant move into such fissures and remain therein after the fluid pressure is reduced below the fracture pressure of the formation 20. The proppant, by appropriate selection of particle size distribution and shape, forms a high permeability channel in the formation 20 that may extend a great lateral distance away from the tubing 24, and such channel remains permeable after the fluid pressure is relieved. The effect of the proppant filled channel is to increase the effective radius of the wellbore 24 that is in hydraulic communication with the producing formation 20, thus substantially increasing productive capacity of the wellbore 24 to hydrocarbons.

The fracturing of the formation 20 by the fluid pressure creates seismic energy that is detected by the seismic sensors 12. The time at which the seismic energy is detected by each of the sensors 12 with respect to the time-dependent position in the subsurface of the formation fracture caused at the fluid front 28 is related to the acoustic velocity of each of the formations 16, 18, 20, and the position of each of the seismic sensors 12. One example technique for determining the place and time of origin (“hypocenter”) of each microseismic event is described in U.S. Pat. No. 7,663,970 issued to Duncan et al. In the present example embodiment, the seismic sensors 20 may be “three component” seismic sensors, that is, sensor that measure ground movement so as to enable resolution of the ground movement along three mutually orthogonal directions. Such directions may be gravitationally vertical, and two directions orthogonally transverse to gravitationally vertical.

While the wellbore 24 shown in FIG. 1 extends essentially vertically through the formations, it will be appreciated by those skilled in the art that the geodetic trajectory of the wellbore in other examples may be deviated from vertical, or may be drilled initially vertically and then have the trajectory changed so that the wellbore follows a selected path through the formations. Examples of such trajectory may include following the geologic layering attitude of the formations, e.g., horizontal or nearly horizontal, so that the wellbore extends for a substantial lateral distance through one or more selected formations. In certain types of wellbores, fracturing operations may be performed at selected longitudinal positions along a particular wellbore, each such operating being referred to as a fracturing “stage.”

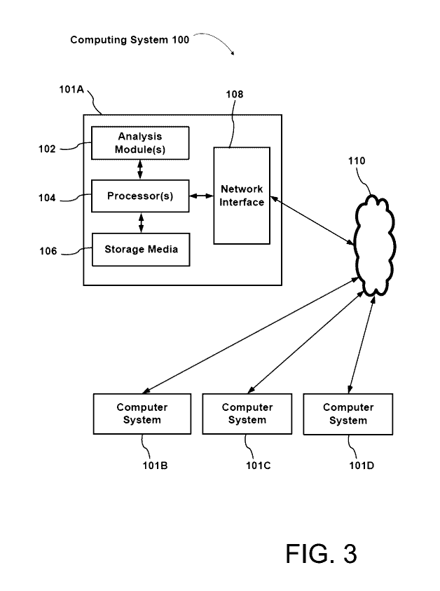

Having explained one type of passive seismic data that may be used with methods according to the invention, a method for processing such seismic data will now be explained. The seismic signals recorded from each of the sensors 12 may be entered into a computer or computer system (FIG. 3) and processed first by certain procedures well known in the art of seismic data processing, including the summing described above, and various forms of filtering. In some embodiments, the sensors 12 may be arranged in directions substantially along a direction of propagation of acoustic energy that may be generated by the pumping unit 32, in the embodiment of FIG. 1, radially outward away from the wellhead 30. By such arrangement of the seismic sensors 12, noise from the pumping unit 32 and similar sources near the wellhead 30 may be attenuated in the seismic signals by frequency-wavenumber (f k) filtering. Other processing techniques for noise reduction and/or signal enhancement will occur to those of ordinary skill in the art.

After such optional initial processing, the seismic signals entered into the computer or computer system may be processed as follows.

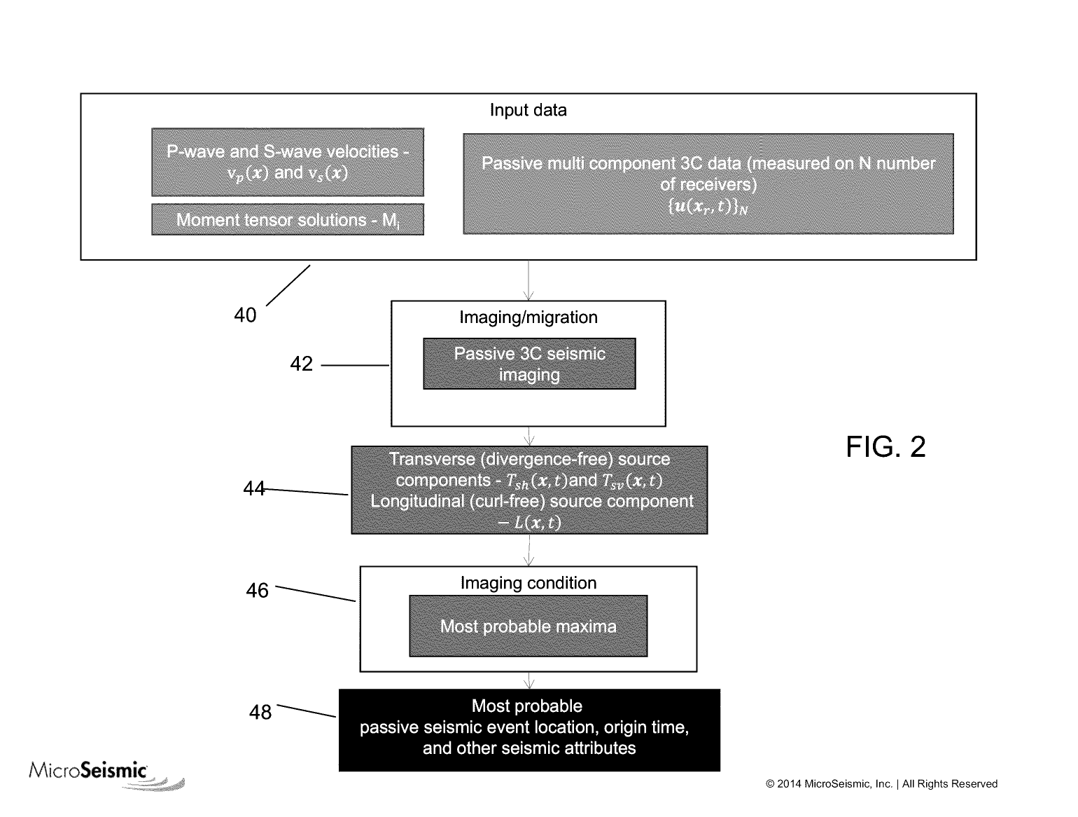

Referring to FIG. 2, at 40, the input seismic signals represent the vector field of displacement, velocity, or acceleration of ground motion, {u(xᵣ, t)}_{N}, the terms of which will be defined below.

The present method may use a priori knowledge of compressional (P-wave) and shear (S-wave) velocities of the formations (16, 18, 20 in FIG. 1) disposed between any one or more microseismic events and the seismic sensors (12 in FIG. 1). The P- and S-wave velocities may be expressed in terms of scalar fields vₚ(x) and vₛ(x), respectively. In some embodiments, the P- and S-wave velocities may be determined from well log measurements, and may be calibrated by scanning or travel-time tomography methods, which use an event with a known spatial position (e.g., an explosive perforation shot discharged in a well drilled through the subsurface formations) and measurement of the arrival time of energy from the event to each of the seismic sensors (12 in FIG. 1). At 42, the velocities are used as scalar multipliers for calculating travel times between locations in subsurface and the seismic sensor locations, τ_{P/S}(x, xᵣ). Although at 42, the method assumes an isotropic velocity field, the method can be extended to anisotropic velocities, where the scalars are approximated and T_{P/S}(x, xᵣ) can be exactly calculated. Moment tensor solutions, Mᵢ, may be derived from world stress mass or by different inversion techniques from the input seismic signals. At 42 in FIG. 2, techniques known in the art, for example, as described in U.S. Pat. No. 7,978,563 issued to Thornton et al. may be used to produce a 3-component image of the events in the subsurface.

The displacement vector u(x, t) of an isotropic material body is governed by the elastic wave equation, which can be represented by pair of acoustic equations (Shearer, P., 2009, Introduction to Seismology, Second Edition, Cambridge University Press):

$$\frac{1}{{{v}_{p} ( x )}^{2}} \frac{{\partial }^{2} ( ∇ \cdot u ( x , t ) )}{\partial {t}^{2}} - Δ ( ∇ \cdot u ( x , t ) ) = \frac{∇ \cdot f ( x , t )}{{{v}_{p} ( x )}^{2} ρ ( x )}$$

$$\frac{1}{{{v}_{s} ( x )}^{2}} \frac{{\partial }^{2} ( ∇ u ( x , t ) )}{\partial {t}^{2}} - Δ ( ∇ u ( x , t ) ) = \frac{∇ f ( x , t )}{{{v}_{s} ( x )}^{2} ρ ( x )}$$

where vₚ(x) and vₛ(x) are P- and S-wave velocities, respectively, ρ(x) is the density of the material, ∇·is a divergence operator, Δ is a Laplace operator, ∇×is a curl operator, and f(x, t) is a vector force density or seismic source term.

In passive seismic surveying, the objective is to identify the microseismic events, which may be described by a source term, f (x, t). The microseismic events may be identified by measuring the motion (e.g., displacement), u(x, t), on or below the Earth's surface proximate a volume of interest in the subsurface at a set of discrete points {xᵣ}, i.e., the seismic sensor locations. An example of such seismic sensor locations may be that as explained above with reference to FIG. 1.

At 44 in FIG. 2, using Helmholtz decomposition, the above source term may be decomposed into two parts (Muller, G., 2007, Theory of Elastic Waves, University of Hamburg, Samizdat Press), f=fₚ+fₛ, a curl-free longitudinal component and a divergence-free transverse component, represented by fₚ and fₛ respectively, so that:

∇·(x,t)=∇fp(x,t)=L(x,t) [longitudinal P component]

∇×f(x,t)=∇×fₛ(x,t)=T(x,t) [transverse S component]

If the velocity and density distribution of the formations are known or assumed, the passive seismic imaging/inversion problem becomes linear; thus, following geometrical optics theory, the above described L(x, t) and T(x, t) components may be estimated with a far-field displacement approximation, similar to that described in Haldorsen, J., Brooks, N., Milenkovic, M., 2013, Locating microseismic sources using migration-based deconvolution, Geophysics, 78(5), 78KS73-78KS8:

$$L ( x , t ) = \frac{{{v}_{p} ( x )}^{2} ρ ( x )}{N} {\sum }_{r} {A}_{M} ( x , {x}_{r} ) u ( {x}_{r} , t + {τ}_{P} ( x , {x}_{r} ) ) \cdot \hat{r}$$

$$T ( x , t ) = \frac{{{v}_{s} ( x )}^{2} ρ ( x )}{N} {\sum }_{r} {B}_{M} ( x , {x}_{r} ) u ( {x}_{r} , t + {τ}_{s} ( x , {x}_{r} ) ) \hat{r}$$

where A_{M}(x, xᵣ) and B_{M}(x, xᵣ) are amplitude and polarity corrections for moment tensor (M) effect (Thornton, M., and L. Eisner, Method for passive seismic emission tomography including polarization correction for source mechanism, U.S. Pat. No. 7,978,563 issued Jul. 12, 2011) and wave propagation (such as, spherical divergence and absorption) for P and S-waves, respectively, τₚ(x, xᵣ) and τₛ(x, xᵣ) are P- and S-wave travel times, and \hat{r} represents a unit vector of a ray at X from Xᵣ

Finally, one may use the energy of the components, at 46 in FIG. 2, to create a seismic image i(x,t) which may be identified as a correlation of RMS values along the time axis (t-axis) of L(x, t) and T(X, t)=|T(x,t)|=\sqrt{Tₛᵥ²+Tₛₕ²}:

i(x,t)_{RMS}=L_{RMS}(x,t)T_{RMS}(x,t)

The seismic image, at 48 in FIG. 2 may be considered to be a local maximum likelihood estimator of the passive event location (see, Gamier, J., 2011, Imaging in Random Media, Gene Golub SIAM Summer School: Waves and Imaging, University of British Columbia, Vancouver, Canada.). Therefore, the estimated origin time, t₀, and estimated location, x_{img}, of any one or more seismic events may be determined by the expressions:

$${t}_{0} = {argmax}_{t} i ( x , t )$$

$${x}_{img} = {argmax}_{x} i ( x , t )$$

FIG. 3 shows an example computing system 100 in accordance with some embodiments. The computing system 100 may be an individual computer system 101A (e.g., as may be disposed in the recording unit 10 in FIG. 1) an arrangement of distributed computer systems. The individual computer system 101A may include one or more analysis modules 102 that may be configured to perform various tasks according to some embodiments, such as the tasks explained with reference to FIG. 2. To perform these various tasks, the analysis module 102 may operate independently or in coordination with one or more processors 104, which may be connected to one or more storage media 106. A display device 105 such as a graphic user interface of any known type may be in signal communication with the processor 104 to enable user entry of commands and/or data and to display results of execution of a set of instructions according to the present disclosure.

The processor(s) 104 may also be connected to a network interface 108 to allow the individual computer system 101A to communicate over a data network 110 with one or more additional individual computer systems and/or computing systems, such as 101B, 101C, and/or 101D (note that computer systems 101B, 101C and/or 101D may or may not share the same architecture as computer system 101A, and may be located in different physical locations, for example, computer systems 101A and 101B may be at a well drilling location, while in communication with one or more computer systems such as 101C and/or 101D that may be located in one or more data centers on shore, aboard ships, and/or located in varying countries on different continents).

A processor may include, without limitation, a microprocessor, microcontroller, processor module or subsystem, programmable integrated circuit, programmable gate array, or another control or computing device.

The storage media 106 may be implemented as one or more computer-readable or machine-readable storage media. Note that while in the example embodiment of FIG. 8 the storage media 106 are shown as being disposed within the individual computer system 101A, in some embodiments, the storage media 106 may be distributed within and/or across multiple internal and/or external enclosures of the individual computing system 101A and/or additional computing systems, e.g., 101B, 101C, 101D. Storage media 106 may include, without limitation, one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that computer instructions to cause any individual computer system or a computing system to perform the tasks described above may be provided on one computer-readable or machine-readable storage medium, or may be provided on multiple computer-readable or machine-readable storage media distributed in a multiple component computing system having one or more nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that any other embodiment of a computing system may have more or fewer components than shown, may combine additional components not shown in the example embodiment of FIG. 8, and/or the computing system 100 may have a different configuration or arrangement of the components shown in FIG. 8. The various components shown in FIG. 8 may be implemented in hardware, software, or a combination of both hardware and software, including one or more signal processing and/or application specific integrated circuits.

Further, the acts of the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for passive seismic imaging, comprising:
entering into a programmable computer seismic signals measured at a plurality of spaced apart locations proximate a volume of Earth's subsurface to be evaluated, the seismic signals measured at each location along different directions to enable resolution of motion in three orthogonal directions;
in the computer, determining a seismic moment tensor for at least one seismic event occurring in the subsurface from the measured seismic signals;
in the computer, determining divergence-free transverse and curl-free longitudinal components of a source term derived from the seismic moment tensor of the at least one seismic event; and
in the computer, generating an image at at least one point in the subsurface using the determined divergence-free transverse and curl-free longitudinal components.

2. The method of claim 1 wherein the divergence-free transverse and curl-free longitudinal components of a source term derived from the seismic moment tensor are determined using Helmholtz decomposition.

3. The method of claim 1 further comprising estimating energy of the at least one seismic event using a far-field displacement approximation.

4. The method of claim 1 wherein the at least one seismic event comprises a fracture created by pumping fluid into a subsurface formation.

5. The method of claim 1 wherein the image comprises a local maximum likelihood estimate of the passive event location.

6. The method of claim 1 wherein a formation velocity distribution in the volume of the Earth's subsurface is known or determinable a priori.

7. The method of claim 1 wherein the seismic signals at each location are measured along three mutually orthogonal directions.

8. A method for imaging fractures induced in a subsurface formation, comprising:
pumping fluid into the subsurface formation to induce at least one fracture therein;
measuring seismic signals at spaced apart locations proximate the subsurface formation;
entering the measured seismic signals into a computer;
identifying a position of the at least one fracture from the measured seismic signals;
in the computer, determining a seismic moment tensor for at least one seismic event occurring in the subsurface from the measured seismic signals;
in the computer, determining divergence-free transverse and curl-free longitudinal components of a source term derived from the seismic moment tensor of the at least one seismic event; and
in the computer, generating an image at at least one point in the subsurface using the determined divergence-free transverse and curl-free longitudinal components.

9. The method of claim 8 wherein the divergence-free transverse and curl-free longitudinal components of a source term derived from the seismic moment tensor are determined using Helmholtz decomposition.

10. The method of claim 8 further comprising estimating energy of the at least one seismic event using a far-field displacement approximation.

11. The method of claim 8 wherein the at least one seismic event comprises a fracture created by pumping fluid into a subsurface formation.

12. The method of claim 8 wherein the image comprises a local maximum likelihood estimate of the passive event location.

13. The method of claim 8 wherein a formation velocity distribution in the volume of the Earth's subsurface is known or determinable a priori.

14. The method of claim 8 wherein the seismic signals at each location are measured along three mutually orthogonal directions.
